(19) United States
(12) Patent Application Publication
(10) Pub. No.: US 2009/0320939 A1
(43) Pub. Date: Dec. 31, 2009

(54) Check Valve

(75) Inventor: Henry Loos, Strongsville, OH (US)

Correspondence Address: KED Innovations, Inc.;Kurt Loos, 3900 Woodberry Drive, Medina, OH, 44256, US

(73) Assignee: KED Innovations, Inc., Medina, OH (US)

(21) Appl. No.: 12/491,797

(22) Filed: Jun. 25, 2009

Related U.S. Application Data
(60) Provisional application No. 61/075,721, filed on Jun. 25, 2008.

(51) Int. Cl. F16K 15/00

(52) U.S. Cl. 137/535

(57) ABSTRACT

An improved check valve that can exhibit satisfactory sealing performance for hundreds of thousands of forward and reverse flow cycles under the severe conditions encountered in an application such as a carwash. The check valve may reduce the number of possible failure points found in conventional check valves and may reduce the risk of failure associated with other possible failure points that may not be eliminated.

This application claims priority to U.S. Ser. No. 61/075,721 titled CHECK VALVE, filed Jun. 25, 2008, which is incorporated herein by reference.

### I. BACKGROUND

A. Field of Invention

This invention pertains to the art of methods and apparatuses regarding fluid valves and more specifically to methods and apparatuses regarding one-way check valves used to prevent the backflow of a fluid.

B. Description of the Related Art

Typically, in a vehicle washing installation, or a carwash, the cleaning process includes utilizing a plurality of nozzle arrangements to dispense various fluids onto the vehicle. The nozzle arrangements are in communication with a fluid pumping station via a plurality of fluid circuits. The fluid pumping station provides the various types of fluids to be utilized during operation of the carwash. A single wash cycle may require the fluid pumping station to cause the various fluids to be dispensed onto a vehicle in a predetermined order and for a predetermined period of time. For example, a single wash cycle may require the fluid pumping station to dispense water, soap, liquid car wax and surface protectant as well as other cleaning fluids at varying pressures and temperatures.

Check valves are commonly used in many fluid systems to prevent the flow of fluid in a first direction while permitting the flow of fluid in a second direction. In a carwash application, check valves are used to direct the multiple high and low pressure fluid circuits as opposed to a system that subjects the check valve to only relatively infrequent backflow situations or functions to protect against backflow in the event of a system failure. Each wash cycle can expose the check valve to multiple forward and reverse flow cycles. These flow cycles may subject the check valve to conditions including fluid pressures of up to 1200 psi, fluid temperatures of up to 120° F., and variations in the fluid pH level ranging from about 2 to about 13. Typically, the check valve is exposed to tens of thousands of forward and reverse flow cycles per year.

Conventionally, check valve seat/seal combinations for preventing the flow of fluid include a resilient seal element that is efficient at creating an impermeable seal against the flow of fluid. The resilient seal elements are especially effective at low pressures, which are generally considered to be pressures less than 100 psi. The resilient seal elements must be attached to the seat or seal of the check valve, thereby requiring the check valve to comprise multiple internal parts and fasteners. Some resilient seal elements also include a guide, such as a shaft, to center the seal against the seat. Commonly, a fluid system is designed for use with only a single type or class of fluid. As a result, the materials used to form the check valve, including the resilient seal member, are selected to be resistant to the particular type or class of fluid used within the fluid system.

Although known check valves work well for their intended purpose, several disadvantages exist. The severe conditions occurring during a wash cycle of a carwash commonly cause premature catastrophic failure of the check valve seat, the resilient seal member, and/or the internal fasteners. The catastrophic failure of the check valve seat, the resilient seal member, or the internal fasteners can cause a total loss of system functionality. The total loss of system functionality may damage the fluid system thereby necessitating costly repairs to the system as well as the resultant lost revenue caused by the inoperability of the carwash.

What is needed then is a check valve which can exhibit satisfactory sealing performance for hundreds of thousands of forward/reverse flow cycles under the severe conditions encountered in an application such as a carwash without catastrophic failure and that provides increased reliability and performance when subjected to high fluid pressures and temperatures as well as extreme variation in the fluid pH levels.

### II. SUMMARY

One advantage of the invention is that the improved check valve exhibits satisfactory sealing performance for hundreds of thousands of forward/reverse flow cycles under the severe conditions encountered in an application such as a carwash without catastrophic failure and provides increased reliability and performance when subjected to high fluid pressures and temperatures as well as extreme variation in the fluid pH levels.

Another advantage of the invention is that the check valve reduces the number of possible failure points found in conventional check valves, and reduces the risk of other possible failure points that are not eliminated.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 shows an angled, side, perspective view of a check valve according to one embodiment of the invention;

FIG. 2 shows an end view of the check valve shown in FIG. 1;

FIG. 3 shows a sectional view of the check valve shown in FIG. 2, along line A-A;

FIG. 4 shows an assembly view of a check valve according to one embodiment of the invention;

FIG. 5 shows an angled, side, perspective view of a body of a check valve according to one embodiment of the invention;

FIG. 6 shows an end view of the body shown in FIG. 5;

FIG. 7 shows a sectional view of the body shown in FIG. 6, along line A-A;

FIG. 8 shows an angled, side, perspective view of a cap of a check valve according to one embodiment of the invention;

FIG. 9 shows an end view of the cap shown in FIG. 8;

FIG. 10 shows a sectional view of the cap shown in FIG. 9, along line A-A;

FIG. 11 shows an angled, side, perspective view of a poppet for a check valve according to one embodiment of the invention;

FIG. 12 shows an end view of the poppet shown in FIG. 11;

FIG. 13 shows a side view of the poppet shown in FIG. 11;

FIG. 14 shows a sectional view of the poppet shown in FIG. 12, along line A-A;

FIG. 15 shows an angled, side, perspective view of a check valve according to one embodiment of the invention;

FIG. 16 shows an end view of the check valve shown in FIG. 15;

FIG. 17 shows a sectional view of the check valve shown in FIG. 16, along line A-A;

FIG. 18 shows an assembly view of the check valve shown in FIG. 15;

FIG. 19 shows an angled, side, perspective view of a body for a check valve according to one embodiment of the invention;

FIG. 20 shows an end view of the body shown in FIG. 19;

FIG. 21 shows a sectional view of the body shown in FIG. 20, along line A-A;

FIG. 22 shows an angled, side, perspective view of a cap for a check valve according to one embodiment of the invention;

FIG. 23 shows an end view of the cap shown in FIG. 22;

FIG. 24 shows a sectional view of the cap shown in FIG. 23, along line A-A;

FIG. 25 shows an angled, side, perspective view of a poppet for a check valve according to one embodiment of the invention;

FIG. 26 shows a side view of the poppet shown in FIG. 25;

FIG. 27 shows an end view of the poppet shown in FIG. 25;

FIG. 28 shows a sectional view of the poppet shown in FIG. 27, along line A-A.

### IV. DETAILED DESCRIPTION

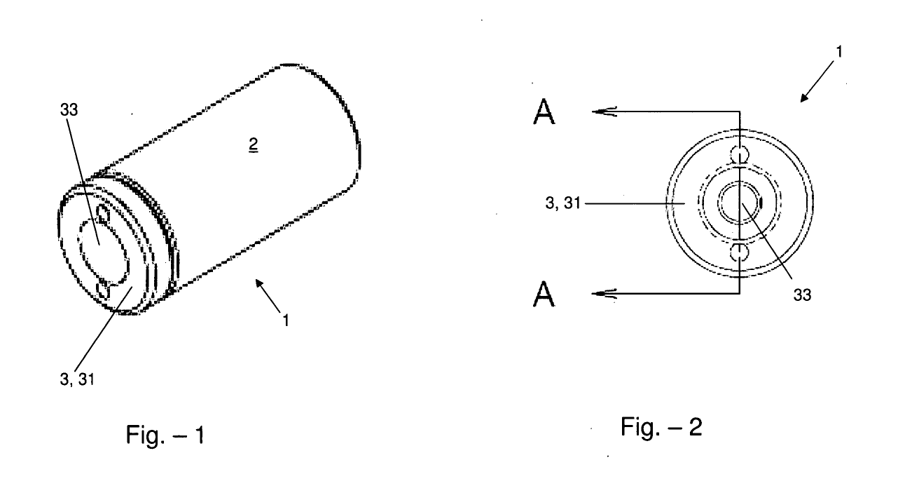

Referring now to the drawings wherein the showings are for purposes of illustrating embodiments of the invention only and not for purposes of limiting the same, FIG. 1 shows a check valve 1 comprising a cylindrical, two-piece housing having a static axial face seal, a poppet-style sealing element, and a biasing member wherein the check valve 1 is suitable for use within a highly corrosive, high pressure, high cycle operation, such as, for example, a car wash. The check valve 1 may provide an improved check valve that can exhibit satisfactory sealing performance for hundreds of thousands of forward and reverse flow cycles under the severe conditions encountered in an application such as a carwash. The check valve 1 may reduce the number of possible failure points found in conventional check valves and may reduce the risk of failure associated with other possible failure points that may not be eliminated.

In one embodiment, the check valve 1 comprises a non-corrosive material that allows the check valve 1 to be substantially chemically resistant to the pressure, temperature, and pH; as well as substantially resistant to mechanical wear encountered in a severe, high cycle application such as a carwash. In one embodiment, the check valve 1 may comprise cost effective material that exhibits low water absorption. In a more specific embodiment, the check valve 1 may substantially comprise a copolymer acetal. The check valve 1 may comprise any composition chosen with sound judgment by a person of ordinary skill in the art.

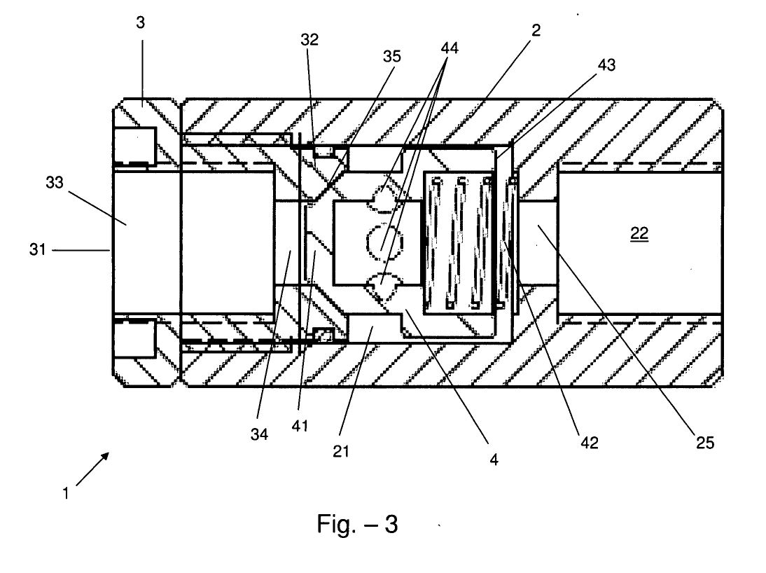

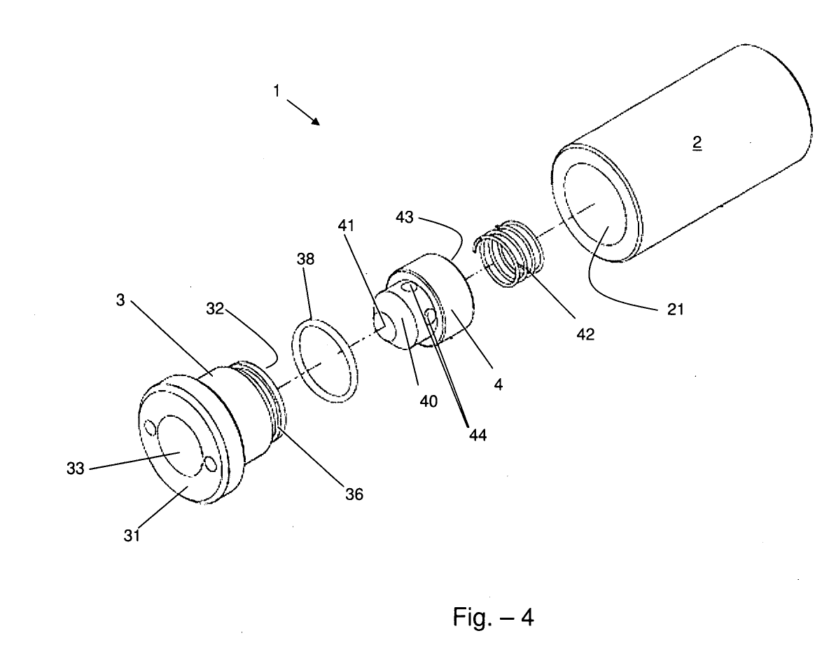

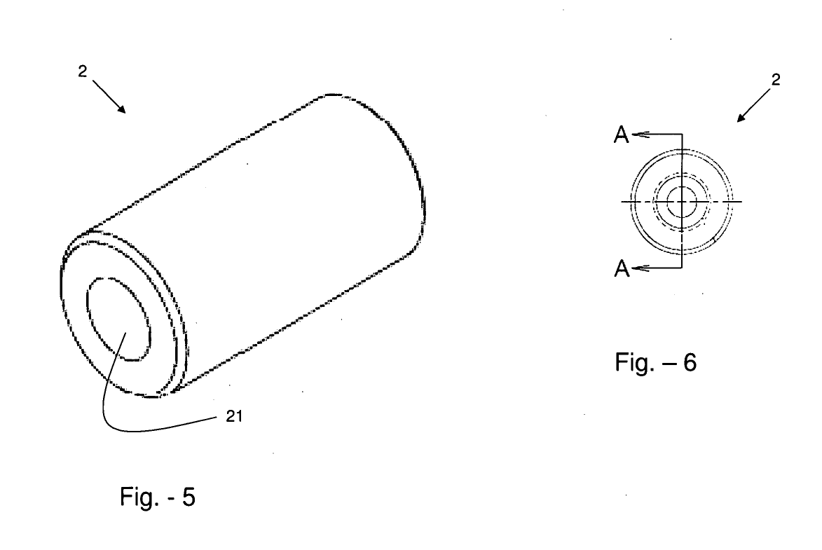

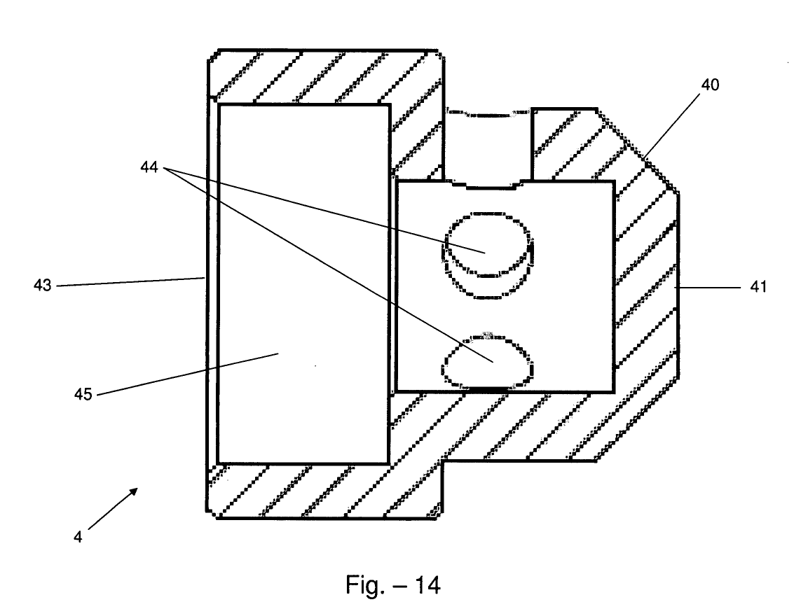

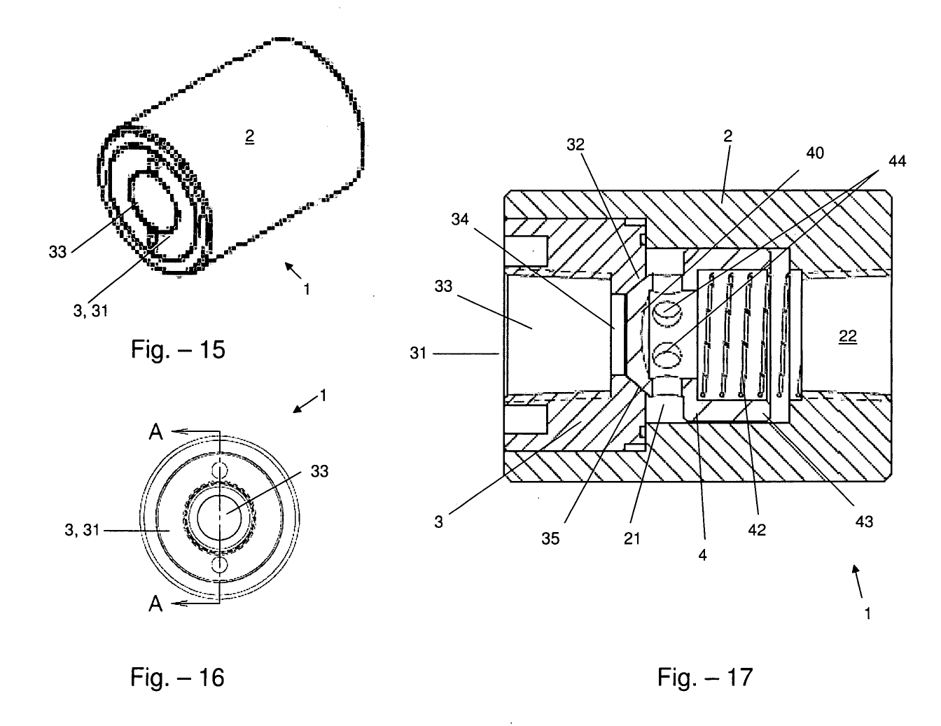

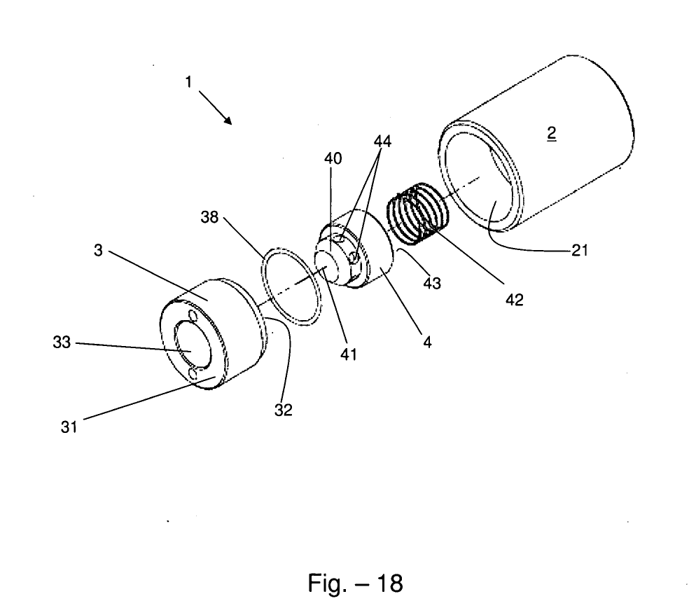

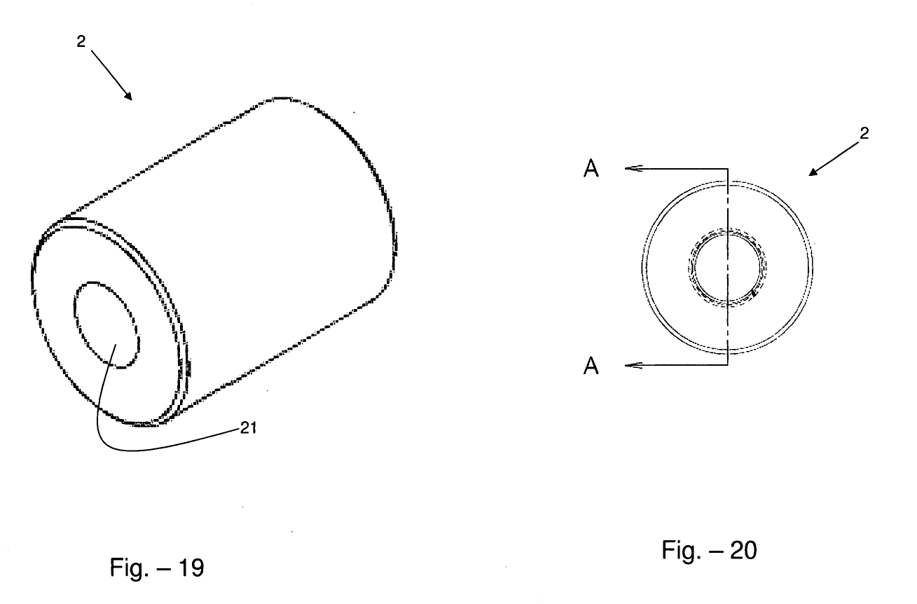

With reference now to FIGS. 1-7 and 15-21, the check valve 1 may comprise a device that can be used to control the flow of fluid within a fluid system. The check valve 1 may allow fluid to be communicated or flow in a forward direction and may prevent fluid from flowing in a reverse direction as more fully described below. The check valve 1 may comprise a substantially cylindrically-shaped two-piece housing comprising a body 2, a cap 3, a poppet 4, and a biasing member 42. The body 2 may comprise a substantially cylindrical shape and may define a first recess 21 and a second recess 22. In one embodiment, a fluid passage 25 may extend through the body 2 such that fluid can be communicated between the first and second recesses 21, 22. The cap 3 may comprise a substantially cylindrically-shape and may be operatively connected to the body 2. The cap 3 may comprise a first end 31 and a second end 32. In one embodiment, the cap 3 may be operatively connected to the body 2 such that the second end 32 at least partially extends into the body 2 and the first end 31 is positioned adjacent to the first end 21 of the body 2, as shown in FIG. 1. In another embodiment, the cap 3 may be operatively connected to the body 2 such that the cap 3 is positioned substantially within the body 2 such that the first end 31 of the cap 3 is positioned substantially flush with the first end 21 of the body 2, as shown in FIG. 15. A failure point can exist at the union between the cap 3 and the body 2. In one embodiment, to minimize the risk of the union failing, the cap 3 may comprise a first set of threads 36. The first set of threads 36 may be received by a corresponding second set of threads 23 positioned on the body 2, as is well known in the art, to operatively connect the cap 3 to the body 2 such that the cap inlet 31 is in fluid communication with the first recess 21 as more fully described below. In a more specific embodiment, the cap 3 may be threaded into the body 2 using large, 1 15/16″ diameter 12 threads per inch course threads for a total of 12 threads so as to withstand the force of up to 4000 psi.

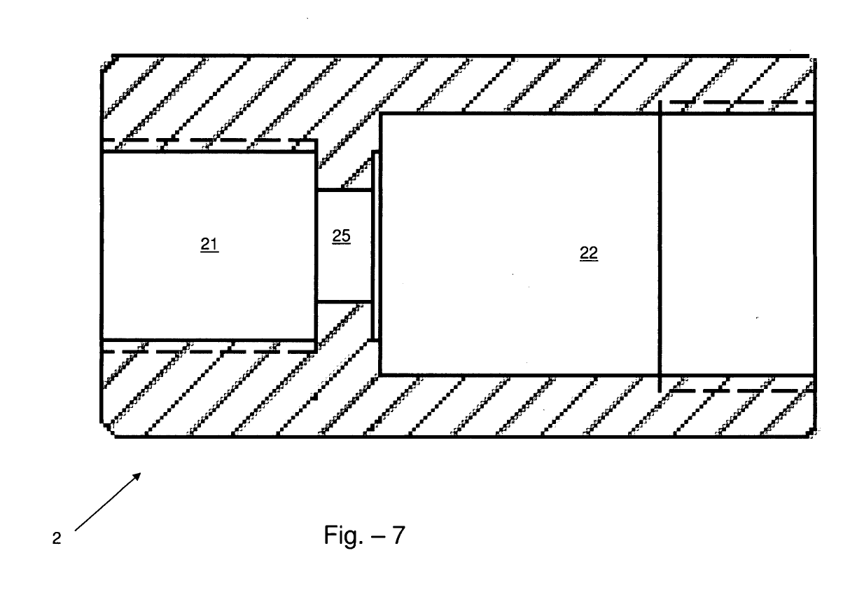

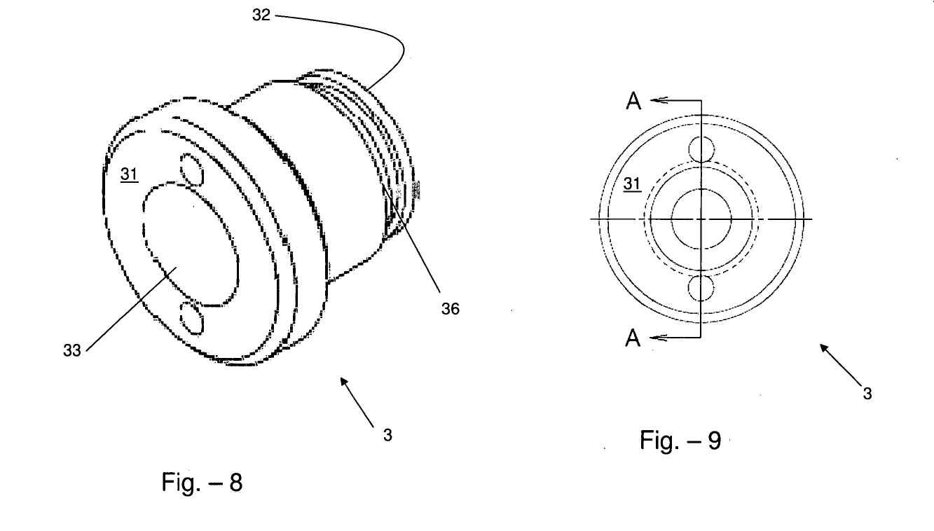

With reference now to FIGS. 1-4, 8-10, 15-18, and, 22-24 a cap inlet 33 may be formed in the first end 31 and a cap outlet 34 may be formed in the second end 32. The cap inlet 33 and the cap outlet 34 may be in fluid communication to form a fluid passage that extends axially through the cap 3. The second end 32 may comprise a static axial face seal or seat 35. The seat 35 may be positioned around the cap outlet 34 and may operate in conjunction with the poppet 4 to prevent the reverse flow of fluid through the check valve 1 as more fully described below. The seat 35 and cap 3 may comprise a one-piece design and may comprise substantially the same material the poppet 4 such that any wearing of the seat 35 that may occur over hundreds of thousands of cycles is substantially reduced, thereby minimizing the risk of failure of the seat 35. In one embodiment, the cap 3 may include an o-ring seal 38 positioned between the cap 3 and the body 2. The o-ring seal 38 may comprise a resilient, corrosion resistant material, such as, for example Teflon.

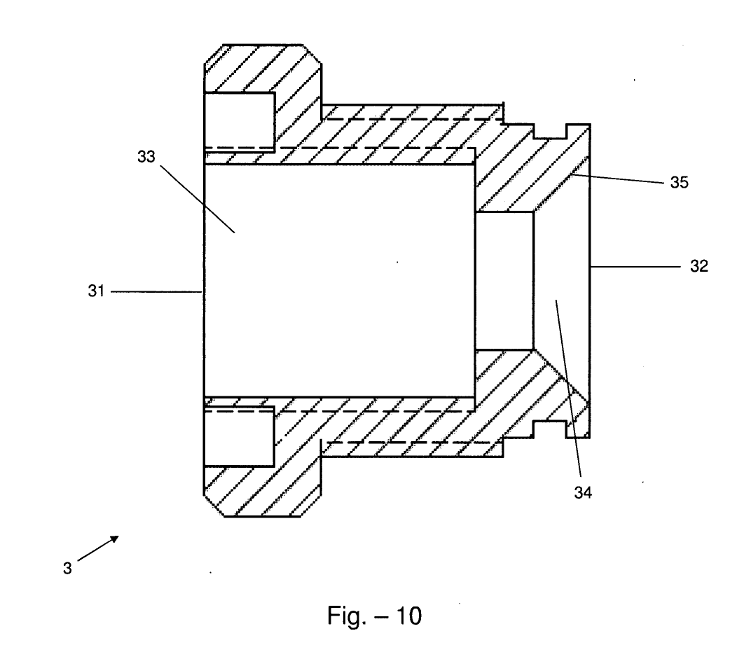

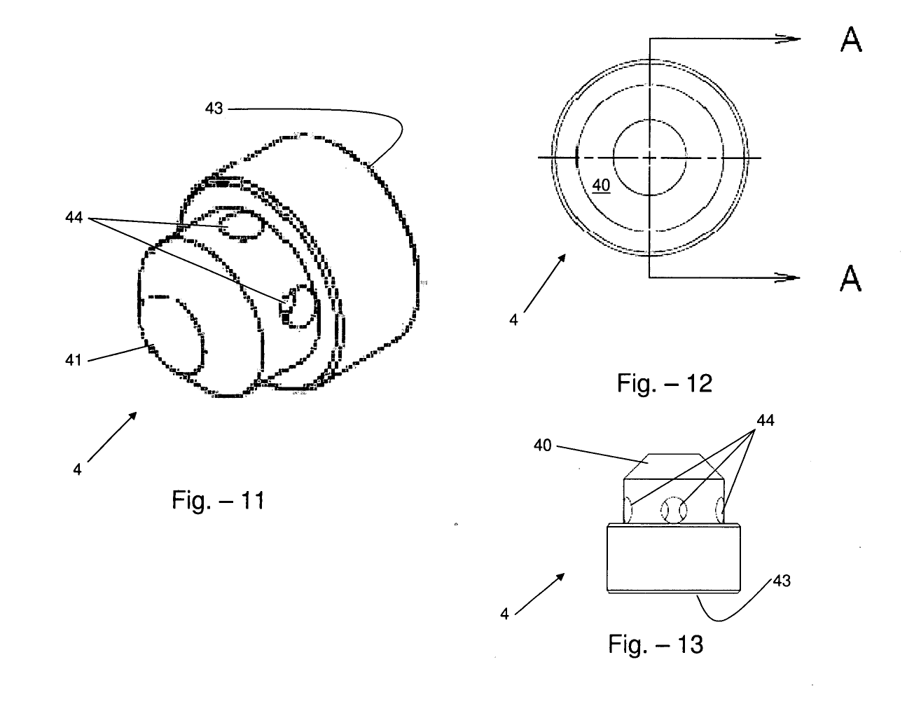

With reference now to FIGS. 1-4, 11-18, and, 25-28, the poppet 4 may comprise a poppet-style sealing element that is positioned substantially within the first recess 21. The poppet 4 may be substantially concentrically positioned within the first recess 21. The poppet 4 may be formed of substantially the same composition as the body 2. In one embodiment, the poppet 4 may comprise Copolymer Acetal. The poppet 4 may be machined or formed to a dimension that is slightly smaller than the internal bore diameter of the portion of the body 2 defining the radial limits of the first recess 21. The dimensions of the poppet 4 may be such that the movement of the poppet 4 is at least partially guided within the first recess 21 by the inner surface of the body 2 that defines the radial limits of the first recess 21 thereby eliminating the need for any type of guide or centering device, such as, for example, a shaft, found in a conventional check valve. In a more specific embodiment, the poppet 4 may be formed to have an outer diameter of about 1.48 inches. The poppet 4 may comprise a sufficient thickness that minimizes the risk of seal failure caused by normal wear resulting from use of the check valve 1 that may normally occur over hundreds of thousands of cycles. In one embodiment, the poppet 4 may be machined or formed to a thickness of about 0.20″. The thickness of the poppet 4 may at least partially depend upon the type of material used to form the poppet 4 and the specific application for which the check valve 1 is used in conjunction with. The thickness of the poppet 4 can be determined by a person of ordinary skill in the art without undue experimentation.

With continuing reference to FIGS. 1-4, 11-18, and, 25-28, the poppet 4 may comprise a sealing surface 40 formed in a first end 41 of the poppet 4. The sealing surface 40 may comprise an angled surface that cooperates with the seat 35 to create a barrier or seal that can prevent the flow of fluid between the cap 3 and body 2. The biasing member 42 may be positioned within the first recess 21. The biasing member 42 may urge the poppet 4 away from a center section 24 thereby urging the sealing surface 40 into contact with the seat 35 to form the seal or barrier described above. Due to the high pressure caused by fluid flowing in the reverse direction (defined more fully below), the resilient seal member found in conventional check valves is not necessary to exhibit a satisfactory seal since the reverse pressure assists in urging the poppet 4 towards the seat 35. The poppet 4, therefore, may eliminate two points of failure associated with conventional check valves: the resilient seal member; and, any conventional fastener used to attach the resilient seal member to the conventional check valve. The biasing member 42 may comprise a corrosion resistant member having sufficient durability as can be determined without undue experimentation by a person of ordinary skill in the art. In one embodiment, the biasing member 42 may comprise a spring 42 positioned between the center section 24 and a second end 43 of the poppet 4. In a more specific embodiment, the spring 42 may comprise 304 stainless steel. The poppet 4 may comprise a plurality of circumferentially spaced fluid passages 44. The fluid passages 44 may at least partially allow fluid to be communicated from the first recess 21 and through the poppet 4. Fluid communicated from the first recess 21 may exit the poppet 4 via a poppet outlet 45 formed through the second end 43 of the poppet 4.

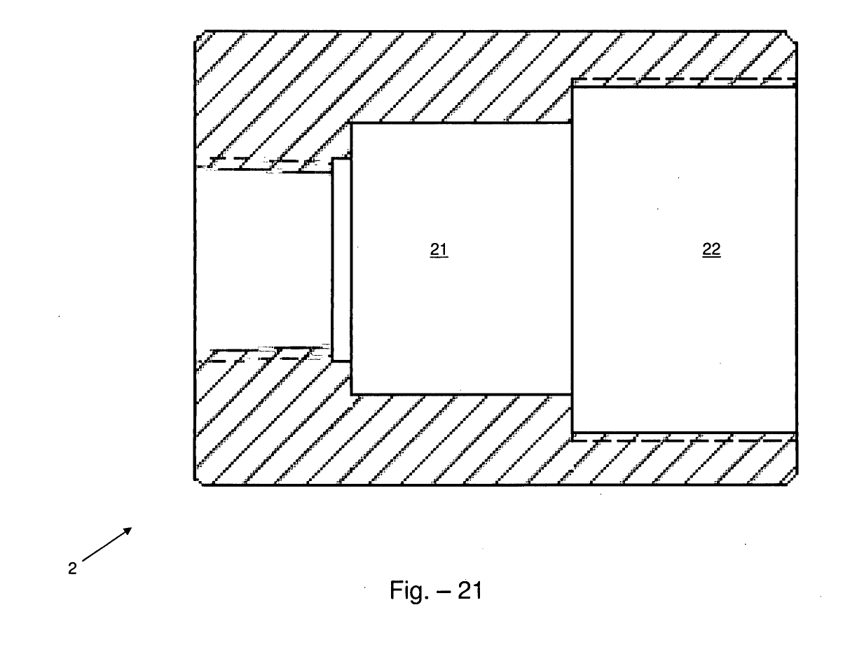

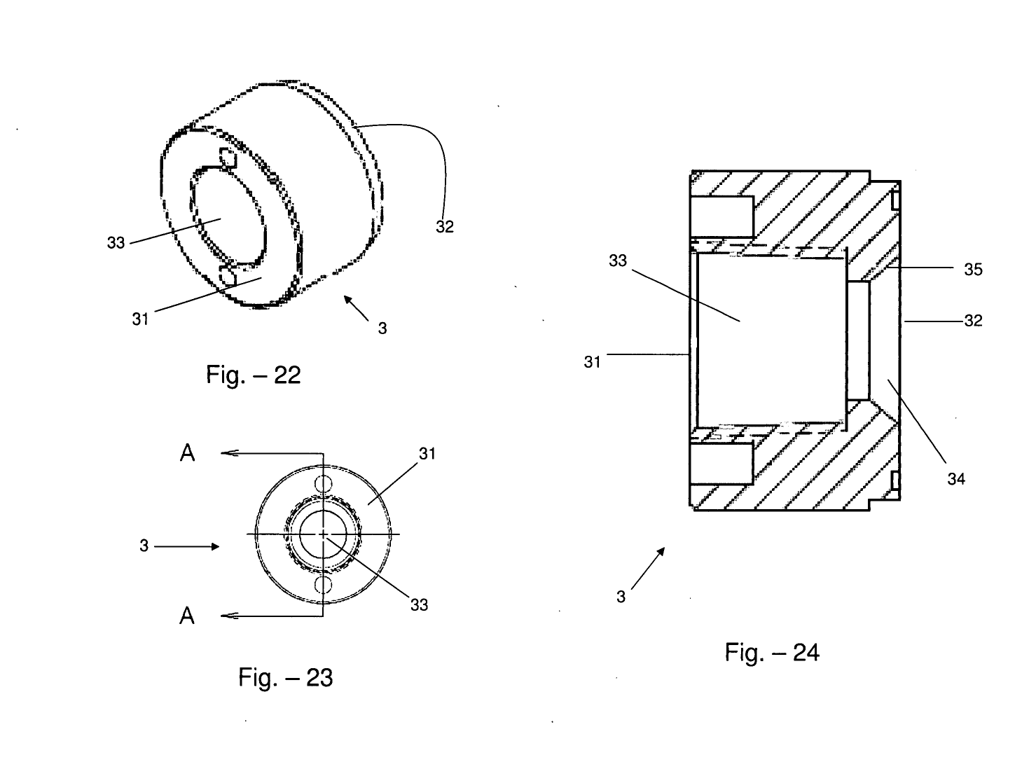

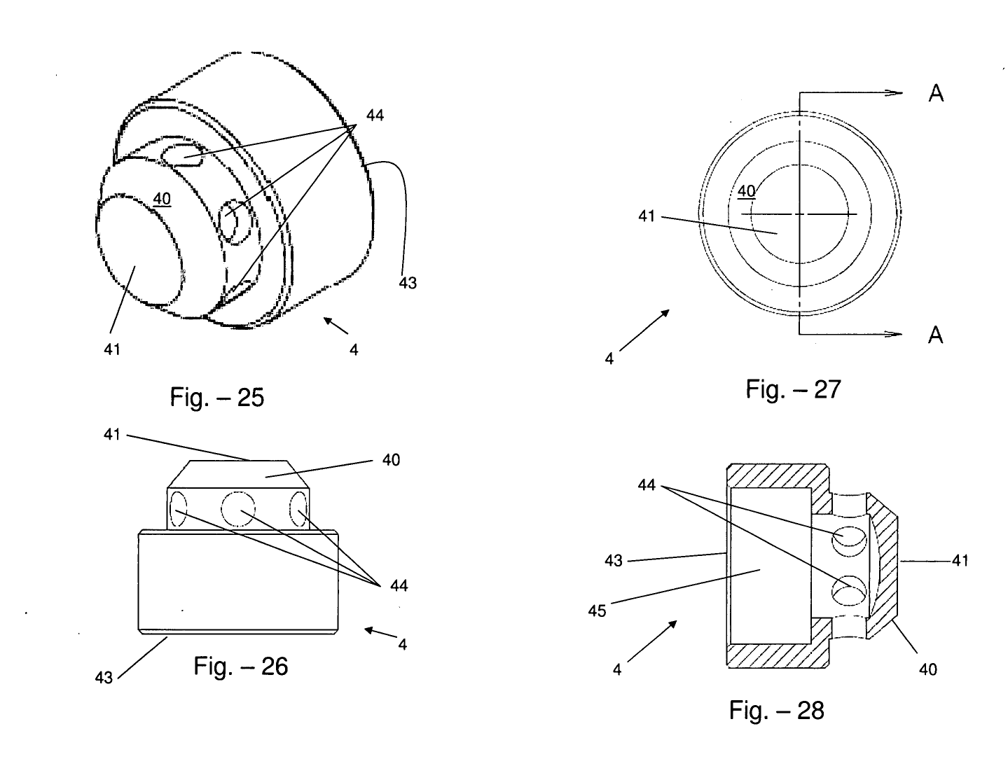

With reference now to FIGS. 1-28, the operation of the check valve 1 will generally be described. The check valve 1 may be positioned within a fluid system to allow the flow of fluid in a forward direction while preventing the reverse flow of fluid. The check valve 1 may be positioned within a fluid system such that fluid flowing in a forward direction enters the check valve 1 through the cap inlet 33. Initially, the biasing member 42 may at least partially cause the sealing surface 41 to be urged into contact with the seat 35. Fluid entering the cap 3 through the cap inlet 33 may at least partially cause a force to be exerted against the sealing surface 41. The force exerted against the sealing surface 41 may be sufficient to cause the poppet 4 to move generally downward towards the center section 24. The downward movement of the poppet 4 may cause the sealing surface 41 to move to a position that allows fluid to flow from the cap 3 and into the first recess 21. The fluid passages 43 may allow fluid entering the first recess 21 to flow through the poppet 4. The fluid passage 25 may allow fluid communicated through the poppet 4 to flow into the second recess 22 thereby allowing the fluid to exit the check valve 1 via an outlet 26 formed in the end of the body 2.

With continuing reference to FIGS. 1-28, the check valve 1 may be positioned within the fluid system such that fluid flowing in a reverse direction enters the check valve 1 through the outlet 26 and into the second recess 22. The fluid passage 25 may allow the fluid to flow through the fluid passages 43 and enter the first recess 21 wherein the positioning of the sealing surface 41 prevents the fluid from entering the cap 3. As described above, the biasing member 42 may at least partially cause the sealing surface 41 to be urged into contact with the seat 35. Additionally, the fluid entering the first recess 21 may exert a reverse pressure or force upon the sealing surface 41 that further urges the sealing surface 41 into contact with the seat 35 thereby creating a seal that substantially completely prevents fluid flowing from the first recess 21 into the cap 3. Due to the high pressure at reverse flow conditions, the resilient seal found in conventional check valves is not necessary to exhibit a satisfactory seal since the reverse pressure assists in urging the sealing surface 41 into contact with the seat 35. As stated above, by eliminating the resilient seal of conventional check valves, the check valve 1 eliminates two points of failure found in conventional check valves: (1) the resilient seal; and, (2) the fastener or other means used to attach the resilient seal to the poppet.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A check valve comprising:
a substantially cylindrical housing comprising:
a body comprising a first end that defines a first recess;
a cap operatively connected to the first end of the body, wherein the cap comprises an inlet, an outlet, and a seat positioned around the outlet;
a poppet positioned substantially within the first recess and comprising a sealing surface, a plurality of fluid passages and an outlet; and,
a biasing member positioned within the body,
wherein the biasing member urges the poppet in a first direction to at least partially cause the sealing surface to contact the seat thereby causing a seal to be formed that substantially prevents a fluid from entering the cap from the body through the cap outlet while allowing fluid to enter the body from the cap through the cap outlet.
